(19) United States
(12) Patent Application Publication
(10) Pub. No.: US 2026/0252013 A1
(43) Pub. Date: Aug. 27, 2026

(54) IMAGE FORMING APPARATUS HAVING DETECTION UNIT FOR DETECTING SHEET CHARACTERISTICS AND METHOD

(71) Applicant: CANON KABUSHIKI KAISHA, Tokyo (JP)

(72) Inventors: YOHEI KATTO, Chiba (JP); SEITA INOUE, Chiba (JP)

(21) Appl. No.: 19/356,958

(22) Filed: Oct. 13, 2025

(30) Foreign Application Priority Data
Oct. 25, 2024 (JP) 2024-188096

(51) Int. Cl. G03G 15/00

(52) U.S. Cl. CPC G03G 15/5029; G03G 15/502; G03G 15/6514; G03G 2215/00734

(57) ABSTRACT

An image forming apparatus that forms an image on a sheet includes a stacking unit on which sheets are stacked, a conveyance unit that conveys a sheet from the stacking unit, a detection unit that detects characteristics of the sheet, a display unit that displays information, and a control unit that controls the display unit, wherein, in a mode where the detection unit detects the characteristics of the sheet, the control unit controls the display unit to display a screen for inputting information about a sheet shape.

### BACKGROUND

### Field of the Technology

The present disclosure relates to image forming apparatuses such as printers, copiers, facsimiles, and multifunction peripherals, and a method for controlling an image forming apparatus.

### Description of the Related Art

An image forming apparatus develops an electrostatic latent image formed on a photosensitive member with toner, transfers a developed toner image to a sheet, and fixes the toner image. Sheets are set in a manual feed tray or a sheet feed cassette and fed one by one therefrom. Sheets may have different sheet characteristics such as the thickness and the surface property. The image forming apparatus performs image formation by changing operating conditions of an image forming operation according to the sheet characteristics. The sheet characteristics are manually set from an operation unit or the like by a user or set through detection by a medium sensor disposed on a conveyance path where a sheet is conveyed. Japanese Patent Laid-Open No. 2022-62122 describes an image forming apparatus that determines operating conditions of an image forming operation including sheet feed conveyance control based on the sheet characteristics detected by a medium sensor.

It has not been considered to detect the shape of a sheet by a detection unit that detects sheet characteristics conventionally, and there has been room for further improvement.

### SUMMARY

According to an aspect of the present disclosure, an image forming apparatus that forms an image on a sheet includes a stacking unit on which sheets are stacked, a conveyance unit configured to convey a sheet from the stacking unit, a detection unit configured to detect characteristics of the sheet, a display unit configured to display information, and a control unit configured to control the display unit, wherein, in a mode where the detection unit detects the characteristics of the sheet, the control unit controls the display unit to display a screen for inputting information about a sheet shape.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an image forming apparatus according to a present embodiment.

FIG. 2 is a block diagram illustrating a control system of the image forming apparatus.

FIG. 3 is a schematic view illustrating a configuration of a medium sensor.

FIG. 4 illustrates a sheet size detection configuration.

FIG. 5 illustrates an initial medium setting screen.

FIG. 6 is a flowchart illustrating medium setting processing according to a first embodiment.

FIG. 7A illustrates a setting selection screen. FIG. 7B illustrates a shape selection screen. FIG. 7C illustrates a sheet type input screen.

FIG. 8 is a flowchart illustrating sheet feed processing.

FIG. 9 is a flowchart illustrating processing for setting a control sheet size according to the first embodiment.

FIG. 10 is a flowchart illustrating medium setting processing according to a second embodiment.

FIG. 11 is a flowchart illustrating processing for displaying a sheet shape selection button.

FIG. 12 illustrates an example of a shape selection screen according to the second embodiment.

FIG. 13 is a flowchart illustrating processing for setting a control sheet size according to a third embodiment.

### DESCRIPTION OF THE EMBODIMENTS

### First Embodiment

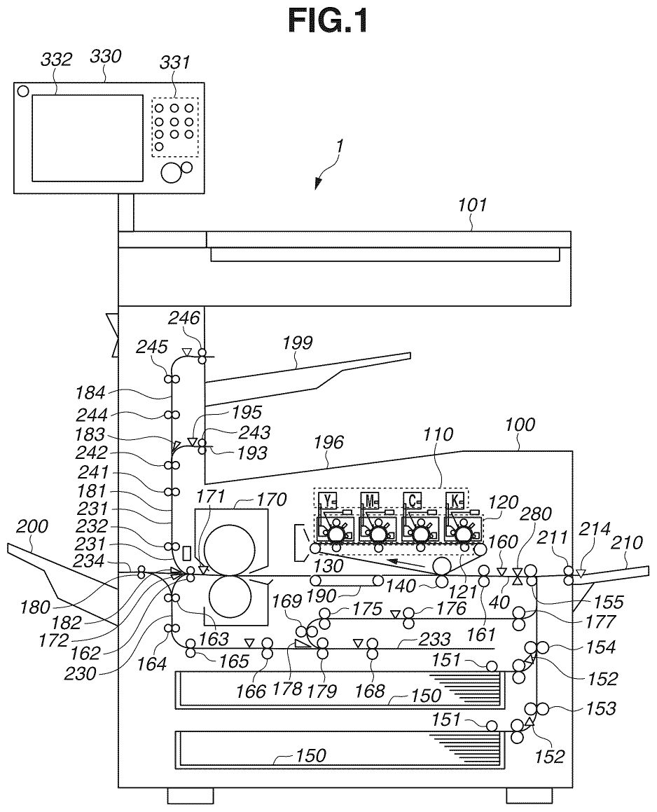

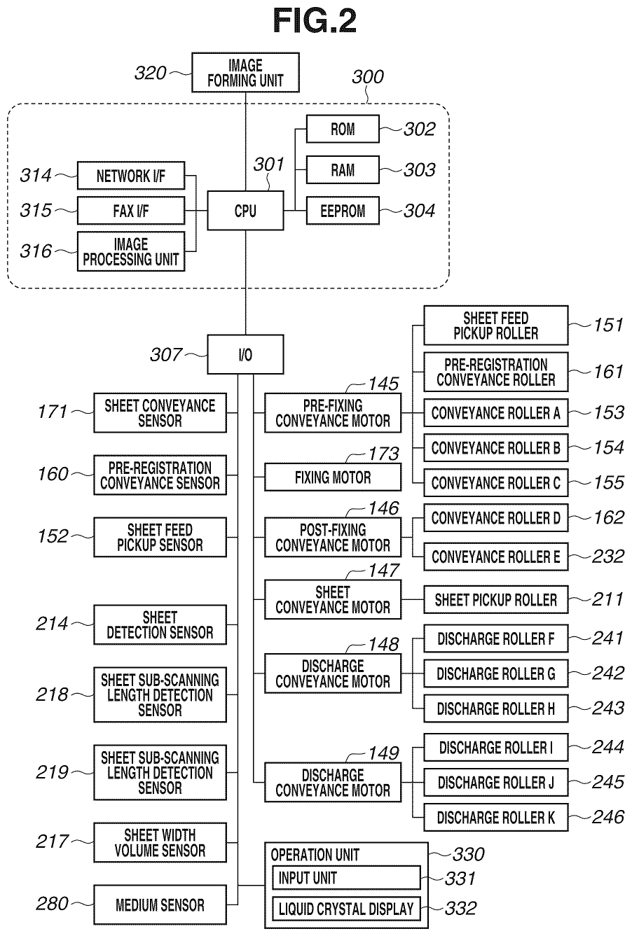

Embodiments of the present disclosure will be described below with reference to the accompanying drawings. FIG. 1 is a schematic view illustrating a configuration of an image forming apparatus 1 according to a first embodiment. FIG. 2 is a block diagram illustrating a control system that controls the image forming apparatus 1. In the control system of the image forming apparatus, a control unit 300 may be connected with various members other than those illustrated in FIG. 2. Since these members are not essential to the features of the present disclosure, illustration and description thereof are omitted.

The control unit 300 illustrated in FIG. 2 includes a central processing unit (CPU) 301, a read only memory (ROM) 302, a random access memory (RAM) 303, and an electrically erasable programmable read-only memory (EEPROM) 304. The CPU 301 executes programs stored in the ROM 302 and the EEPROM 304 to control an image forming apparatus 1 to form an image on a sheet. The CPU 301 can use the RAM 303 as a work area.

The image forming apparatus 1 includes an operation unit 330 that accepts a user input. The operation unit 330 includes an input unit 331 that enables a user to input an instruction to start a print operation on a sheet (referred to as an image forming job) and various types of information such as sheet information, and a liquid crystal display 332 as a display unit. The liquid crystal display 332 can display various types of information such as various programs, various kinds of data, and various screens (described below). The operation unit 330 may be a touch panel that accepts input of information corresponding to a touch position of a touch operation by the user on a screen displayed on the liquid crystal display 332. The CPU 301 can control the liquid crystal display 332 to display various screens.

The CPU 301 can execute an image forming job, and starts a print operation upon input of an instruction to start an image forming job from the operation unit 330. The CPU 301 can control driving of a pre-fixing conveyance motor 145, a fixing motor 173, a post-fixing conveyance motor 146, a sheet conveyance motor 147, a discharge conveyance motor 148, and a discharge conveyance motor 149 that are all connected via an input/output interface (I/O) 307. The CPU 301 can detect input signals input from a sheet conveyance sensor 171, a pre-registration conveyance sensor 160, and a sheet feed pickup sensor 152 via the input/output interface (I/O) 307.

The CPU 301 can also detect input signals input from a medium sensor 280, a sheet detection sensor 214, a sheet width volume sensor 217, a sheet sub-scanning length detection sensor 218, a sheet sub-scanning length detection sensor 219 via the input/output interface (I/O) 307. The CPU 301 can also accept an instruction to start an image forming job input from a network interface (I/F) 314 and a FAX interface (I/F) 315.

The CPU 301 connects with an image processing unit 316 that processes an image corresponding to an image forming job input from the operation unit 330 or the like, and performs image development, image rotation, and other image processing. The CPU 301 is configured to control an image forming unit 320. The image forming unit 320 includes a process unit 120, a transfer belt 130, a secondary transfer unit 140, and a laser scanner unit 110 illustrated in FIG. 1. The CPU 301 can control the temperature of a heater (not illustrated) of a fixing unit 170 illustrated in FIG. 1. A scanner unit 101 can read a document when copying is performed.

A basic image forming operation will be described with reference to FIGS. 1 and 2. When an instruction to start an image forming job is input from the operation unit 330, the CPU 301 analyzes the image forming job and then starts a print operation. The CPU 301 driving the pre-fixing conveyance motor 145 that is a driving source for a sheet feed pickup roller 151 via the input/output interface (I/O) 307 results in the sheet feed pickup roller 151 being driven to rotate, and sheets in a sheet feed cassette 150 (stacking unit) are conveyed one by one. At this timing, the CPU 301 monitors whether a sheet feeding operation has normally been performed by using the sheet feed pickup sensor 152.

Sheet conveyance from a manual feed tray 210 in which a plurality of sheets can be stacked will now be described.

Sheet conveyance from the sheet feed cassette 150 may be performed in a similar manner, and thus a redundant description thereof will be omitted.

When an instruction to convey a sheet on the manual feed tray 210 is issued from the operation unit 330 in a state where a plurality of sheets is stacked on the manual feed tray 210 (stacking unit), the CPU 301 drives the sheet conveyance motor 147 via the input/output interface (I/O) 307. Then, a sheet pickup roller 211 rotates, and sheets are conveyed one by one from the manual feed tray 210. The sheet conveyance motor 147 and the sheet pickup roller 211 are a part of a conveyance unit. The CPU 301 monitors the pre-registration conveyance sensor 160 and determines whether sheet feeding from the manual feed tray 210 has been normally performed.

In the present embodiment, the sheet may be a sheet having a rectangular or square shape, such as an A-size sheet, a B-size sheet, or a postcard and having no limitation on an image forming region (normal shape sheet), a sheet having a partial limitation on an image forming region such as an envelope having a flap in an open state, an index sheet having an index portion, or a pre-punched sheet having a hole formed therein (sheet having a special shape), a plastic film such as a sheet for an overhead projector, or a recording material such as cloth.

Before starting the sheet feeding operation, the CPU 301 determines the sheet length based on detection results of the sheet detection sensor 214, the sheet width volume sensor 217, the sheet sub-scanning length detection sensor 218, and the sheet sub-scanning length detection sensor 219 disposed on the manual feed tray 210. The sheet length refers to the sheet length in a sheet conveyance direction. For a sheet conveyed from the manual feed tray 210, the sheet characteristics, such as the thickness and the surface property, are automatically detected by the medium sensor 280 disposed in the conveyance path. The CPU 301 changes operating conditions of the image forming operation, such as a fixing temperature and a transfer voltage, based on the detected sheet characteristics. The configuration of the manual feed tray 210 and the medium sensor 280 will be described below.

The CPU 301 starts the image forming operation in the process unit 120 in synchronization with a timing at which a sheet reaches the secondary transfer unit 140. The process unit 120 includes a photosensitive drum, a development unit, a charge roller, a photosensitive drum cleaner, and the like. A surface of the photosensitive drum is charged in the process unit 120, and then an electrostatic latent image is formed on the photosensitive drum by a laser beam emitted from the laser scanner unit 110. The electrostatic latent image formed on the photosensitive drum is developed on the photosensitive drum with toner in the development unit. Then, the toner image developed on the photosensitive drum is applied with a primary transfer voltage at a first transfer portion 121, and then is transferred to the transfer belt 130. The toner image having been transferred to the transfer belt 130 is conveyed to the secondary transfer unit 140 by rotation of the transfer belt 130.

The CPU 301 detects the position of the sheet conveyed by a conveyance roller A 153, a conveyance roller B 154, and a conveyance roller C 155 by monitoring the pre-registration conveyance sensor 160. Then, the CPU 301 controls conveyance of the sheet so that the leading edge of the sheet coincides with the leading edge of the toner image on the transfer belt 130 at the secondary transfer unit 140 in consideration of the timing when the leading edge of the sheet reaches the pre-registration conveyance sensor 160. For example, when the CPU 301 determines that a timing at which the sheet reaches the secondary transfer unit 140 is earlier than a timing at which the toner image reaches the secondary transfer unit 140, the CPU 301 stops the sheet for a predetermined period of time at a pre-registration conveyance roller 161 and then restarts the conveyance. As described above, the CPU 301 applies a secondary transfer voltage to the sheet and the toner image having reached the secondary transfer unit 140 via the secondary transfer unit 140, thus the toner image is transferred to the sheet.

The sheet after the secondary transfer is conveyed to a conveyor belt 190 and the fixing unit 170. The toner image on the sheet is heated and fixed to the sheet in the fixing unit 170. Subsequently, when the leading edge of the sheet after fixing is conveyed to the downstream side in the sheet conveyance direction and reaches the sheet conveyance sensor 171, the CPU 301 performs the following operations. Specifically, based on the contents of the image forming job specified via the operation unit 330 in advance, the CPU 301 determines to which of the sheet conveyance paths A 230, B 231, or C 234 the sheet is to be conveyed by a conveyance roller 162. Based on the determination, the CPU 301 switches a conveyance flapper A 172 and a conveyance flapper B 182 to switch a sheet conveyance destination.

When the image forming job input from the operation unit 330 is a double-sided print job or when the sheet is to be discharged onto a discharge tray A 200 with the printed side facing downward, the CPU 301 switches the conveyance flapper A 172 to convey the sheet to the sheet conveyance path A 230. When the image forming job input from the operation unit 330 is a single-sided print job or when the sheet is to be discharged to a discharge tray B 196 or C 199 in double-sided printing, the CPU 301 switches the conveyance flapper B 182 to convey the sheet to the sheet conveyance path B 231. When the sheet is to be discharged to the discharge tray A 200, the CPU 301 switches the conveyance flapper A 172 and the conveyance flapper B 182 to convey the sheet to the sheet conveyance path C 234.

The sheet that is conveyed to the sheet conveyance path B 231 is conveyed further downstream in the sheet conveyance direction by a conveyance roller E 232. Subsequently, the sheet is conveyed to a sheet conveyance path D 181 and then to the discharge tray B 196 or C 199. The sheet conveyed to the sheet conveyance path D 181 is conveyed further by discharge rollers F 241, G 242, and H 243 driven by the discharge conveyance motor 148. When discharging the sheet to the discharge tray B 196, the CPU 301 switches a flapper 183 to convey the sheet to a conveyance path 193 and then discharge the sheet to the discharge tray B 196. When discharging the sheet to the discharge tray C 199, the CPU 301 switches the flapper 183 to the side of a conveyance path 184. Subsequently, the CPU 301 conveys the sheet to the conveyance path 184 via discharge rollers I 244, J 245, and K 246 driven by the discharge conveyance motor 149, and discharges the sheet to the discharge tray C 199.

In a case where the sheet is to be discharged to the discharge tray A 200 with the printed side facing downward in single-sided printing, the sheet advances to the sheet conveyance path A 230. When the trailing edge of the sheet passes a reversing roller 163, the CPU 301 reverses the driving direction to a direction of the discharge roller 180 to discharge the sheet to the discharge tray A 200.

In double-sided printing, the sheet advances to the sheet conveyance path A 230 and is conveyed to a double-sided printing reversing conveyance path D 233 by double-sided printing conveyance rollers A 164, B 165, C 166, D 179, and E 168. Then, when the trailing edge of the sheet passes the double-sided printing conveyance roller D 179, the CPU 301 switches a double-sided printing reversing flapper 178 to the side of a double-sided printing conveyance roller F 169 to reverse the driving direction. Subsequently, the sheet is conveyed by the double-sided printing conveyance rollers F 169, G 175, H 176, and I 177 and then transferred to the conveyance roller C 155. When the image forming job is completed, the CPU 301 displays a message indicating the end of the job on the operation unit 330.

### Medium Sensor

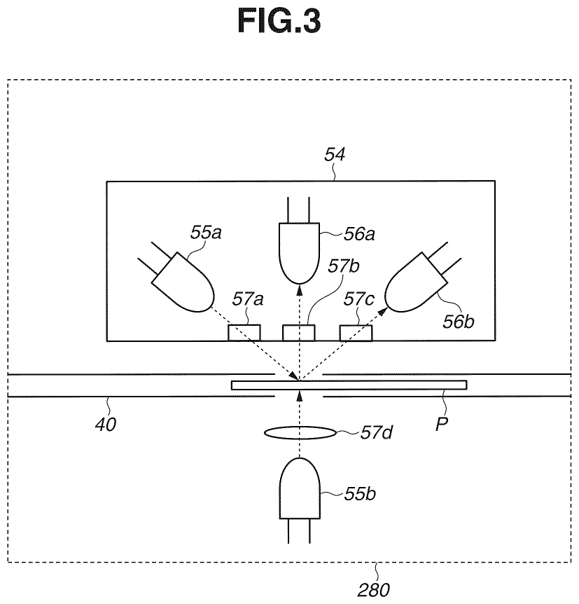

Next, the medium sensor 280 as a detection unit that detects the sheet characteristics of the sheet such as the thickness and the surface property will be described with reference to FIG. 3. As illustrated in FIG. 3, the medium sensor 280 includes a medium sensor main unit 54 and an external light emitting diode (LED) 55b. The medium sensor main unit 54 includes a LED 55a as a light source and photo-transistors 56a and 56b (photo detectors).

### Sheet Surface Property Detection

First, a method for detecting the sheet surface property by the medium sensor 280 will be described. Light emitted from the LED 55a passes through a slit 57a and an upper window of a sheet conveyance guide 40, and is then directed onto the front surface of a sheet P conveyed while being guided by the sheet conveyance guide 40. Reflected light from the sheet P passes through slits 57b and 57c and is received by the photo-transistors 56a and 56b. The photo-transistor 56a receives a part of diffuse reflection light that is light emitted from the LED 55a and reflected on the surface of the sheet P, and then outputs a diffuse reflection output value. The photo-transistor 56b receives specular reflection light that is light emitted from the LED 55a and reflected on the surface of the sheet P, and then outputs a specular reflection output value. A surface property value x is obtained by Equation 1 below:

Surface property value x=Specular reflection output value/Diffuse reflection output value (Equation 1)

Equation 1 utilizes a characteristic that the “smoother” and “finer” the surface property of the sheet P is, the more likely it is to exhibit specular reflection. A calculation device (not illustrated) disposed in the medium sensor 280 quantifies the surface property of the sheet P by using Equation 1, and sends the surface property value x as a calculation result to the CPU 301. The CPU 301 determines the surface property of the sheet P based on the sent surface property value x and a threshold value for determining the surface property. In a case where the surface property value x is greater than the threshold value, the CPU 301 determines that the surface of the sheet P is “smooth” and “fine”. In a case where the surface property value x is less than or equal to the threshold value, the CPU 301 determines that the surface property of the sheet P is “coarse” and “rough”. While a single threshold value is used herein to detect the surface property of the sheet by classifying it into two types, two or more threshold values may be used to enable more finely segmented classification.

### Sheet Thickness Detection

Next, a method for detecting the sheet thickness by the medium sensor 280 will be described. The sheet conveyance guide 40 is provided with a lower window for irradiating the back side of the sheet P with light. The light emitted from the external LED 55b passes through a light condensing guide 57d that condenses light and the lower window, and is directed to the back side of the sheet P. Transmitted light from the sheet P passes through the upper window and the slit 57b, and is received by the photo-transistor 56a. The photo-transistor 56a receives direct transmitted light that is light emitted from the external LED 55b and transmitted through the sheet P, and then outputs a direct transmission output value. The direct transmission output value detected by the photo-transistor 56a is sent to the CPU 301.

The CPU 301 determines the thickness of the sheet P based on the received direct transmission output value and a threshold value for determining the thickness. In the present embodiment, threshold values A and B (threshold value A<threshold value B) are used to determine three types of thickness of “Thick”, “Normal”, and “Thin”. In a case where the direct transmission output value is less than or equal to the threshold value A, the CPU 301 determines that the thickness of the sheet P is “Thin”. In a case where the direct transmission output value is greater than the threshold value A and less than or equal to the threshold value B, the CPU 301 determines that the thickness of the sheet P is “Normal”. In a case where the direct transmission output value is greater than the threshold value B, the CPU 301 determines that the thickness of the sheet P is “Thick”.

While, in the present embodiment, two threshold values are used, one threshold value may be used or three or more threshold values may be used to enable more finely segmented thickness determination. While, in the present embodiment, an optical sensor is used as the medium sensor 280, the sensor is not limited thereto. A sensor of another type, such as an ultrasonic sensor, may be used as long as the sensor can detect the surface property or the thickness.

### Automatic Sheet Size Detection

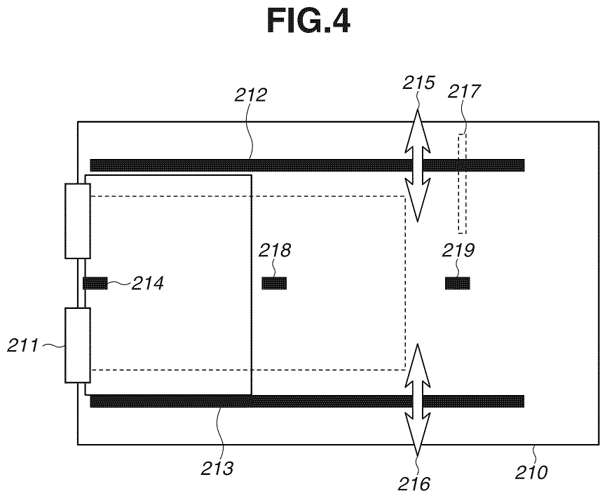

A configuration for automatically detecting the sheet size of the sheet P set in the manual feed tray 210 will be described with reference to FIG. 4. A similar automatic detection configuration may also be applied to the sheet feed cassette 150, and thus description thereof will be omitted here. As illustrated in FIG. 4, the manual feed tray 210 is provided with the sheet pickup roller 211 and sheet side regulation guides 212 and 213. The sheets set in the manual feed tray 210 are sandwiched by the sheet side regulation guides 212 and 213 and are prevented from being conveyed in a skewed state when the sheets are separated and conveyed by the sheet pickup roller 211. The sheet side regulation guides 212 and 213 are provided to be slidable in directions of arrows 215 and 216. This enables preventing the sheet P from being skewed even when sheets having different sheet width are set.

The manual feed tray 210 is also provided with the sheet detection sensor 214, the sheet width volume sensor 217, the sheet sub-scanning length detection sensor 218, and the sheet sub-scanning length detection sensor 219. The sheet detection sensor 214 as an acquisition unit (first detection unit) is provided to detect whether a sheet is stacked on the manual feed tray 210. When a sheet is set on the manual feed tray 210, the sheet detection sensor 214 turns ON, and an ON signal is input from the sheet detection sensor 214 to the CPU 301. The CPU 301 then determines that a sheet is present on the manual feed tray 210. When no sheet is set on the manual feed tray 210, the sheet detection sensor 214 turns OFF, and an OFF signal is input from the sheet detection sensor 214 to the CPU 301. The CPU 301 then determines that no sheet is present on the manual feed tray 210.

The sheet width volume sensor 217 as an acquisition unit (second detection unit) connects with the sheet side regulation guides 212 and 213 via a link member (not illustrated). The sheet width volume sensor 217 outputs a signal (AD value) corresponding to positions of the sheet side regulation guides 212 and 213 to the CPU 301 in conjunction with movements of the sheet side regulation guides 212 and 213. The CPU 301 detects the sheet width based on the signal (AD value) output from the sheet width volume sensor 217. Herein, the sheet width refers to the length in the widthwise direction orthogonal to the sheet conveyance direction (i.e., the main scanning length). The sheet sub-scanning length detection sensor 218 and the sheet sub-scanning length detection sensor 219 as acquisition units (third detection units) are configured as, for example, flag type sensors, and are provided to detect the presence or absence of a sheet based on the length in the sheet conveyance direction of a sheet set on the manual feed tray 210. The CPU 301 can automatically detect the sheet size including the main and the sub-scanning lengths of the sheet P set on the manual feed tray 210 based on a combination of the signals output from the above-described sensors.

### Initial Medium Setting Screen

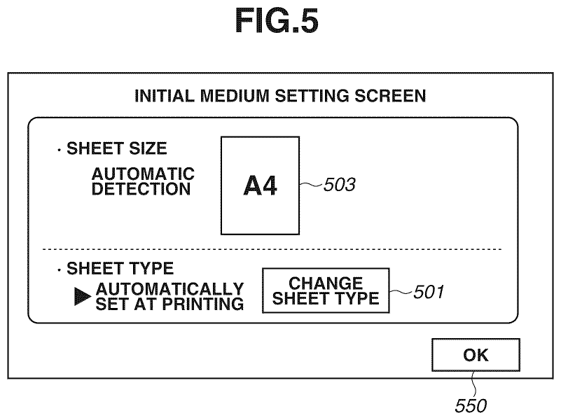

In the present embodiment, in a case where it is detected that a sheet is present on the manual feed tray 210 as described above, “Initial Medium Setting Screen” appears on the liquid crystal display 332 as illustrated in FIG. 5. In the following description, the manual feed tray 210 is used as an example. The configuration may also be applied to the sheet feed cassette 150.

As illustrated in FIG. 5, a detected sheet size 503 automatically detected for the sheet P set on the manual feed tray 210 is displayed on “Initial Medium Setting Screen”. The detected sheet size 503 is displayed based on the main scanning length based on a detection result of the sheet width volume sensor 217 and the sub-scanning length based on detection results of the sheet sub-scanning length detection sensor 218 and the sheet sub-scanning length detection sensor 219. For example, in a case where the main scanning length is “210 mm” and the sub-scanning length is “297 mm”, “A4 Portrait” is displayed as the detected sheet size 503. In a case where the main scanning length is “257 mm” and the sub-scanning length is “182 mm”, “B5 Landscape” is displayed as the detected sheet size 503. While description is omitted herein, the user can also manually input the size of the sheet P set on the manual feed tray 210.

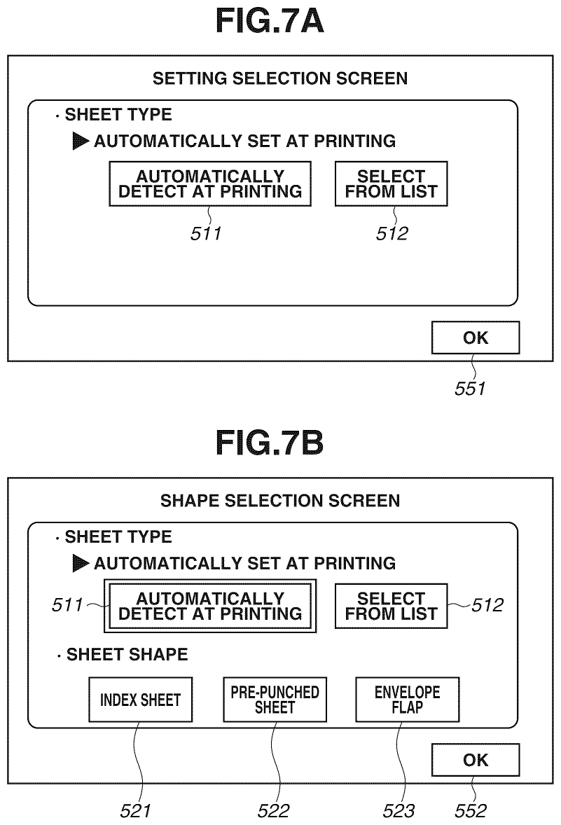

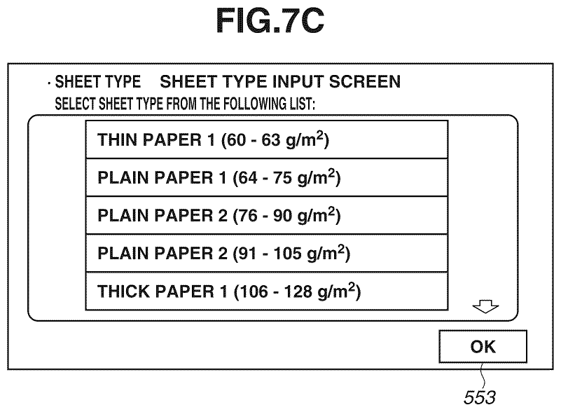

A “Change Sheet Type” button 501 and an “OK” button 550 are displayed on “Initial Medium Setting Screen”. When the “Change Sheet Type” button 501 is pressed, “Setting Selection Screen” (described below with reference to FIG. 7A) appears on the liquid crystal display 332.

### Medium Setting Processing

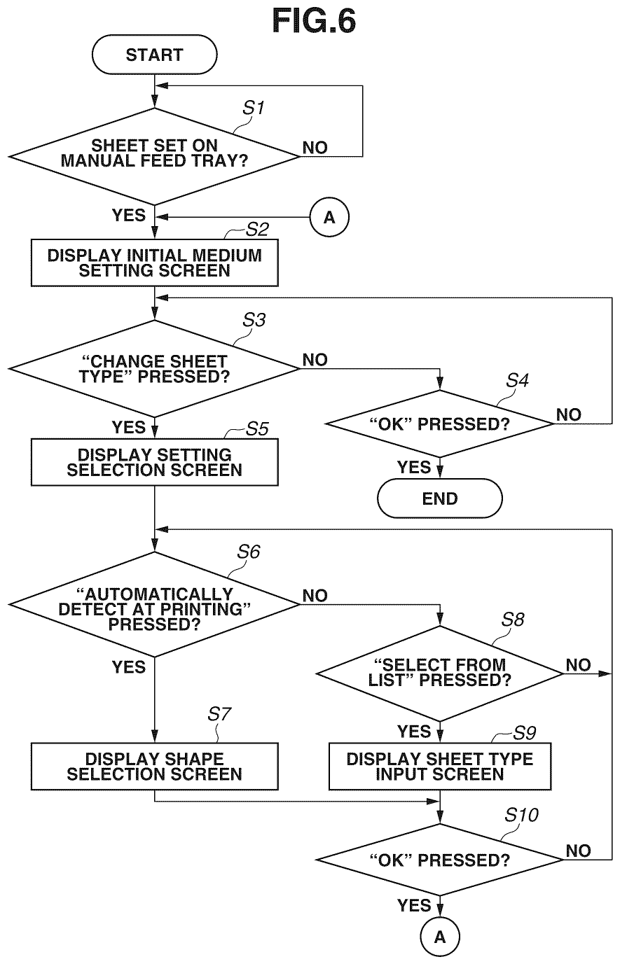

To prompt the user to perform “Medium Setting” including changing the sheet type and setting the sheet shape, various screens that appear on the liquid crystal display 332 starting from “Initial Medium Setting Screen” will be described with respect to FIGS. 5 to 7C with reference to FIG. 2. FIG. 6 is a flowchart illustrating “Medium Setting Processing” according to the first embodiment. Upon execution of “Medium Setting Processing” by the control unit 300, transitions between various screens are performed on the liquid crystal display 332. When power of the image forming apparatus 1 is turned ON, the control unit 300 (more specifically, the CPU 301) starts execution of “Medium Setting Processing”. In the following description, a case where a sheet is set on the manual feed tray 210 is used as an example. Since a similar description applies to a case where a sheet is set in the sheet feed cassette 150, description thereof will be omitted.

As illustrated in FIG. 6, in step S1, the control unit 300 determines whether a sheet is set on the manual feed tray 210 based on a detection result (ON or OFF signal) sent from the sheet detection sensor 214. If no sheet is set on the manual feed tray 210 (NO in step S1), the control unit 300 repeats the processing in step S1. If a sheet is set on the manual feed tray 210 (YES in step S1), the processing proceeds to step S2. In step S2, the control unit 300 displays the above-described “Initial Medium Setting Screen” on the liquid crystal display 332. In this case, the control unit 300 displays the detected sheet size 503 automatically detected.

In step S3, the control unit 300 determines whether the “Change Sheet Type” button 501 on “Initial Medium Setting Screen” is pressed by the user. If the “Change Sheet Type” button 501 is not pressed (NO in step S3), the processing proceeds to step S4. In step S4, the control unit 300 determines whether the “OK” button 550 on “Initial Medium Setting Screen” is pressed by the user. If the “OK” button 550 is not pressed (NO in step S4), the processing returns to step S3. If the “OK” button 550 is pressed (YES in step S4), the control unit 300 ends “Medium Setting Processing”.

If the “Change Sheet Type” button 501 on “Initial Medium Setting Screen” is pressed (YES in step S3), the processing proceeds to step S5. In step S5, the control unit 300 displays “Setting Selection Screen” on the liquid crystal display 332. “Setting Selection Screen” is illustrated in FIG. 7A. As illustrated in FIG. 7A, an “Automatically Detect at Printing” button 511 and a “Select from List” button 512 are displayed on “Setting Selection Screen”. The “Select from List” button 512 enables the user to manually input the sheet type. The “Automatically Detect at Printing” button 511 enables the user to set the automatic detection of the sheet characteristics by the medium sensor 280.

After displaying “Setting Selection Screen”, in step S6, the control unit 300 determines whether the “Automatically Detect at Printing” button 511 on “Setting Selection Screen” is pressed by the user. If the “Automatically Detect at Printing” button 511 is pressed (YES in step S6), the processing proceeds to step S7. In step S7, the control unit 300 display “Shape Selection Screen” on the liquid crystal display 332. At this time, the control unit 300 sets to execute a mode for automatically detecting the sheet characteristics by the medium sensor 280 when the image forming job is executed.

“Shape Selection Screen” is illustrated in FIG. 7B. As illustrated in FIG. 7B, the “Automatically Detect at Printing” button 511 and the “Select from List” button 512 are displayed on “Shape Selection Screen”. The “Automatically Detect at Printing” button 511 is displayed in a non-selectable state on “Shape Selection Screen” so that the button cannot be pressed by the user.

“Shape Selection Screen” is a screen used to input information about the shape of the sheet P, and displays a plurality of candidate images for sheets having special shapes. As the candidate images, sheet shape selection buttons such as an “Index Sheet” button 521, a “Pre-punched Sheet” button 522, and an “Envelope Flap” button 523 are displayed. These sheet shape selection buttons prompt the user to input the shape of the sheets set on the manual feed tray 210. When the user presses the “Index Sheet” button 521, “Index Sheet” that is a special shape can be input. When the user presses the “Pre-punched Sheet” button 522, “Pre-punched Sheet” that is a special shape can be input. When the user presses the “Envelope Flap” button 523, “Envelope Having a Flap in an Open State” that is a special shape can be input. The control unit 300 stores the special shape corresponding to the sheet shape selection button 521, 522, or 523 pressed by the user in the RAM 303.

If the “Automatically Detect at Printing” button 511 on the “Setting Selection Screen” is not pressed by the user (NO in step S6), the processing proceeds to step S8. In step S8, the control unit 300 determines whether the “Select from List” button 512 on the “Setting Selection Screen” is pressed by the user. If the “Select from List” button 512 is not pressed (NO in step S8), i.e., if an “OK” button 551 on the “Setting Selection Screen” is pressed, the processing returns to step S6. If the “Select from List” button 512 is pressed by the user (YES in step S8), the processing proceeds to step S9. In step S9, the control unit 300 displays the “Sheet Type Input Screen” on the liquid crystal display 332.

The “Sheet Type Input Screen” is illustrated in FIG. 7C. The “Sheet Type Input Screen” is a screen used to input information about a plurality of types of sheet P. As illustrated in FIG. 7C, the screen displays a list of sheet types to prompt the user to input a sheet type. On this screen, sheet types (thin paper 1, plain paper 1, and the like) are displayed together with their grammages. The control unit 300 stores a sheet type selected from the list by the user in the RAM 303.

Returning to FIG. 6, in step S10, the control unit 300 determines whether an “OK” button 552 on the “Shape Selection Screen” or an “OK” button 553 on the “Sheet Type Input Screen” is pressed by the user. If the “OK” button 552 on the “Shape Selection Screen” or the “OK” button 553 on the “Sheet Type Input Screen” is pressed by the user (YES in step S10), the processing returns to step S2. In step S2, the control unit 300 displays “Initial Medium Setting Screen” on the liquid crystal display 332.

If the “OK” button 552 on the “Shape Selection Screen” or the “OK” button 553 on the “Sheet Type Input Screen” are not pressed by the user (NO in step S10), the processing returns to step S6. In this case, even if any one of the sheet shape selection buttons 521, 522, and 523 on the “Shape Selection Screen” is pressed, the control unit 300 does not store the special shape corresponding to the sheet shape selection button 521, 522, or 523 pressed by the user in the RAM 303. Even if the user selects any one sheet type from the list on the “Sheet Type Input Screen”, the control unit 300 does not store the sheet type selected by the user in the RAM 303.

### Sheet Feed Processing

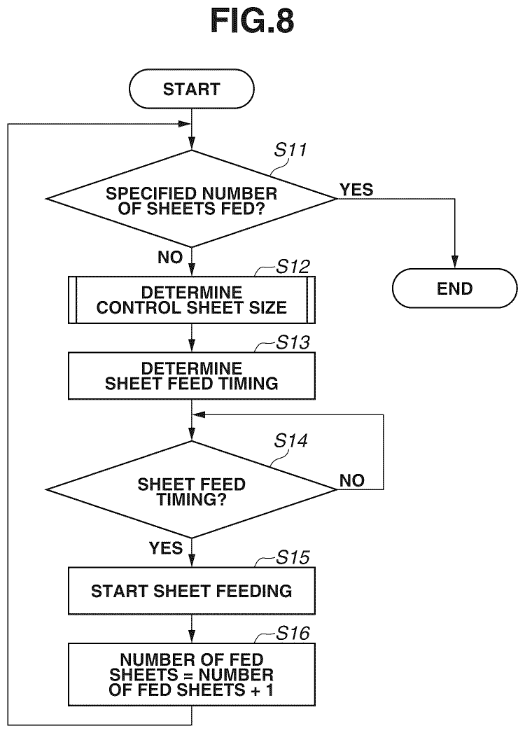

“Sheet Feed Processing” during execution of an image forming job will be described using FIG. 8 with reference to FIG. 2. When an instruction to start an image forming job is input from the operation unit 330, job information is stored in the RAM 303. In this case, the image forming job is a job for forming an image on the desired number of sheets to be fed from the manual feed tray 210. The “Sheet Feed Processing” illustrated in FIG. 8 is executed by the control unit 300 (more specifically, the CPU 301) based on the job information.

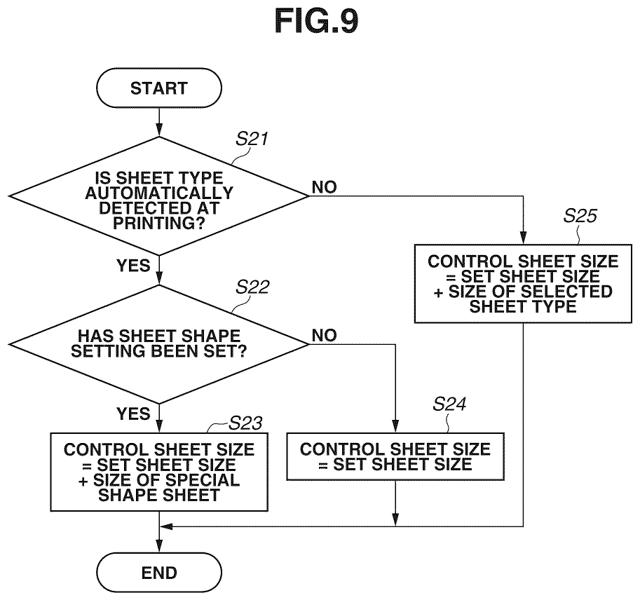

In step S11, the control unit 300 determines whether the number of sheets specified by the user has been fed from the manual feed tray 210. If the specified number of sheets has been fed from the manual feed tray 210 (YES in step S11), the control unit 300 ends the “Sheet Feed Processing”. If the specified number of sheets has not been fed from the manual feed tray 210 (NO in step S11), the processing proceeds to step S12. In step S12, the control unit 300 performs “Control Sheet Size Setting Processing” to determine “Control Sheet Size”. The “Control Sheet Size Setting Processing” will be described below with respect to FIG. 9.

After the “Control Sheet Size Setting Processing” is performed, in step S13, the control unit 300 determines a sheet feed timing to feed a sheet from the manual feed tray 210 according to the “Control Sheet Size”. In step S14, the control unit 300 determines whether it is the determined sheet feed timing. If it is the sheet feed timing (YES in step S14), the processing proceeds to step S15. In step S15, the control unit 300 drives the sheet conveyance motor 147 to rotate the sheet pickup roller 211 to feed sheets one by one from the manual feed tray 210. Thus, a conveyance interval of the sheet P is adjusted. When a sheet is fed from the manual feed tray 210, then in step S16, the control unit 300 increments “Number of Fed Sheets” stored in the RAM 303 by one. The processing then returns to step S11, and the control unit 300 repeats the above-described processing. When the control unit 300 determines whether the specified number of sheets has been fed from the manual feed tray 210 in step S11, the control unit 300 compares “Number of Fed Sheets” stored in the RAM 303 with the specified number of sheets.

When “Number of Fed Sheets” reaches the specified number of sheets, the control unit 300 determines that the specified number of sheets has been fed from the manual feed tray 210.

### Control Sheet Size Setting Processing

“Control Sheet Size Setting Processing” (step S12 in FIG. 8) will be described with reference to FIG. 9. As illustrated in FIG. 9, in step S21, the control unit 300 determines whether the above-described “Automatically Detect at Printing” button 511 (see FIG. 7A) on “Setting Selection Screen” is pressed by the user, i.e., whether the automatic detection of the sheet characteristics by the medium sensor 280 is set to be performed. If the “Automatically Detect at Printing” button 511 is not pressed by the user, i.e., if the automatic detection of the sheet characteristics by the medium sensor 280 is not to be performed (NO in step S21), the processing proceeds to step S25. In step S25, the control unit 300 adds “Set Sheet Size” and the size of a sheet type selected from “Sheet Type Input Screen” (see FIG. 7C) by the user, and sets the resultant size to “Control Sheet Size”. For example, when “Envelope” is selected as the sheet type and “Set Sheet Size” is a Choukei No. 3 envelope (235 mm×120 mm), the control unit 300 sets “265 mm (235+30)” to “Control Sheet Size”. “Set Sheet Size” refers to the sheet size automatically detected on the manual feed tray 210 or the sheet size manually input by the user. “Control Sheet Size” is used to determine the timing of sheet feeding from the manual feed tray 210 as described above during execution of an image forming job (see step S13 in FIG. 8).

If the “Automatically Detect at Printing” button 511 is pressed by the user, i.e., if the automatic detection of the sheet characteristics by the medium sensor 280 is to be performed (YES in step S21), the processing proceeds to step S22. In step S22, the control unit 300 determines whether a sheet shape setting has been set. More specifically, the control unit 300 determines whether the user has pressed any of the sheet shape selection buttons 521, 522, and 523 on the “Shape Selection Screen” (see FIG. 7B) to select a special shape. If no special shape is selected (NO in step S22), the processing proceeds to step S24. In step S24, the control unit 300 sets the “Set Sheet Size” to the “Control Sheet Size”. For example, in a case where the automatically detected sheet size is “A4 Portrait (297 mm×210 mm)”, the control unit 300 sets the “Set Sheet Size” to “297 mm”.

If a special shape is selected (YES in step S22), the processing proceeds to step S23. In step S23, the control unit 300 adds “Set Sheet Size” and a special shape size value preliminary assigned to the selected special shape, and sets the resultant size to the “Control Sheet Size”. For example, when a special shape “Index Sheet” is selected and the automatically detected sheet size is “A4 Landscape”, the control unit 300 adds the special shape size value “12.6 mm” to the length of the short side of the automatically detected A4 whose sheet size is “210 mm×297 mm”, and sets the resultant size “222.6 mm (210+12.6)” to “Control Sheet Size”.

As described above, the conveyance interval of the sheet P is adjusted by the control unit 300 feeding sheets one by one from the manual feed tray 210 based on the sheet feed timing. “Control Sheet Size” is used to determine such sheet feed timing. The conveyance interval of the sheet P refers to an interval between the leading edge of a preceding sheet P and the leading edge of a subsequent sheet P in the sheet conveyance direction. As described above, for example, when the sheet P is “Choukei No. 3 Envelope”, the control unit 300 sets “265 mm” to the “Control Sheet Size”. When the sheet P is “A4 Portrait”, the control unit 300 sets “297 mm” to the “Control Sheet Size”. When the sheet P is “Choukei No. 3 Envelope”, the sheet feed timing of a subsequent sheet P is determined to be earlier than the sheet feed timing of the subsequent sheet P when the sheet P is “A4 Portrait”.

As described above, in the present embodiment, in a case where the automatic detection of the sheet characteristics by the medium sensor 280 is to be performed, “Shape Selection Screen” for prompting the user to input a special shape is displayed on the liquid crystal display 332. When the user inputs a special shape on “Shape Selection Screen”, “Control Sheet Size” corresponding to the input special shape is set. Then, when an image forming job is executed, the sheet P having a special shape is conveyed from the manual feed tray 210 at conveyance intervals adjusted based on “Control Sheet Size”. This enables preventing an occurrence of failure such as a paper jam of the sheet P having a special shape in the conveyance path in the case where the automatic detection of the sheet characteristics by the medium sensor 280 is to be performed. The user can easily set “Control Sheet Size” by just inputting a special shape from “Shape Selection Screen”. This improves the user convenience.

### Second Embodiment

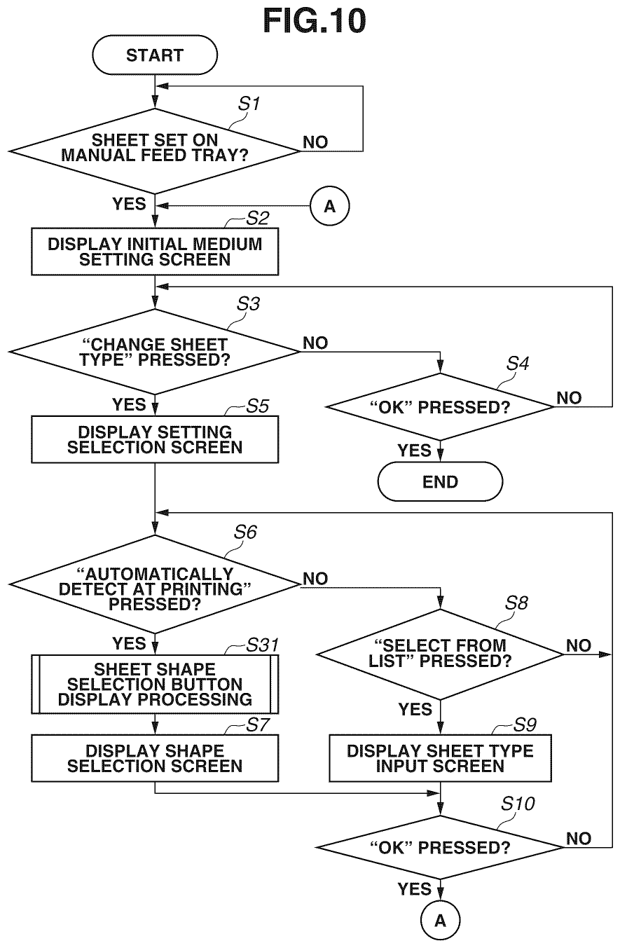

A second embodiment will be described using FIGS. 10 to 12 with reference to FIG. 2. The second embodiment differs from the first embodiment in that at least one of the sheet shape selection buttons 521, 522, or 523 is displayed in a non-selectable state not selectable by the user on “Shape Selection Screen” according to the above-described first embodiment illustrated in FIG. 7B.

FIG. 10 is a flowchart illustrating “Medium Setting Processing” according to the second embodiment. “Medium Setting Processing” according to the present embodiment illustrated in FIG. 10 includes additional processing of step S31 compared to “Medium Setting Processing” according to the first embodiment illustrated in FIG. 6. Thus, herein, processing identical to that of “Medium Setting Processing” according to the first embodiment is assigned the same step number, and description thereof will be simplified or omitted. Processing related to the processing in step S31 will be described.

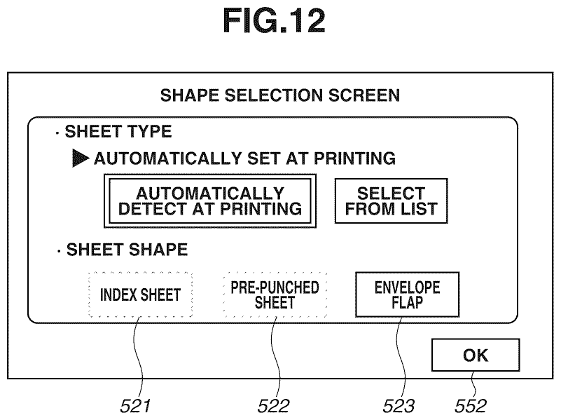

In step S5, the control unit 300 displays “Setting Selection Screen”. In step S6, the control unit 300 determines whether the “Automatically Detect at Printing” button 511 is pressed by the user. If the “Automatically Detect at Printing” button 511 is pressed (YES in step S6), the processing proceeds to step S31. In step S31, the control unit 300 performs “Sheet Shape Selection Button Display Processing”. Then, in step S7, the control unit 300 displays “Shape Selection Screen” (see FIG. 12), on the liquid crystal display 332, on which at least one of the sheet shape selection buttons 521, 522, or 523 determined in “Sheet Shape Selection Button Display Processing” is displayed in a non-selectable state not selectable by the user.

### Sheet Shape Selection Button Display Processing

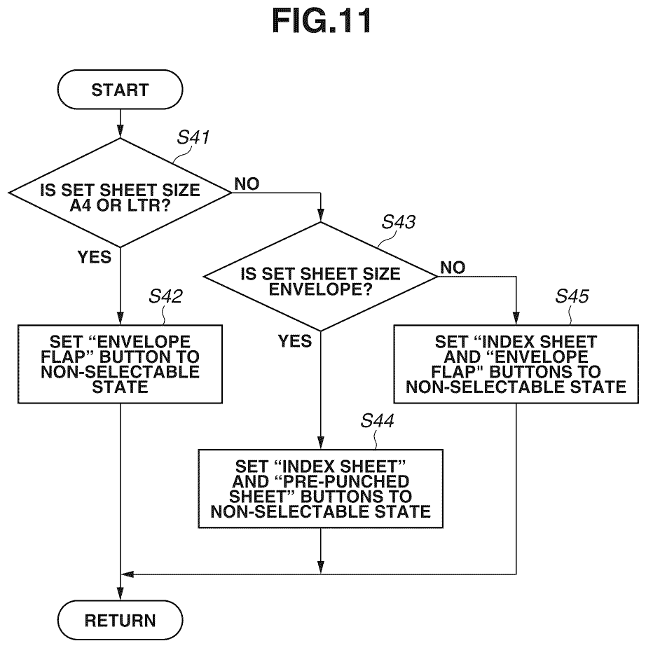

“Sheet Shape Selection Button Display Processing” will be described with reference to FIG. 11. In the present embodiment, “Set Sheet Size” is one of the predetermined sizes “A4”, “LTR”, and “Envelope”. As illustrated in FIG. 11, in step S41, the control unit 300 determines whether “Set Sheet Size” is “A4” or “LTR”. If “Set Sheet Size” is “A4” or “LTR” (YES in step S41), the processing proceeds to step S42. In step S42, the control unit 300 sets the “Envelope Flap” button 523 to a non-selectable state. In this case, the “Index Sheet” button 521 and the “Pre-punched Sheet” button 522 are sheet shape selection buttons that can be selected by the user.

If “Set Sheet Size” is neither “A4” nor “LTR” (NO in step S41), the processing proceeds to step S43. In step S43, the control unit 300 determines whether “Set Sheet Size” is “Envelope”. If “Set Sheet Size” is “Envelope” (YES in step S43), the processing proceeds to step S44. In step S44, the control unit 300 sets the “Index Sheet” button 521 and the “Pre-punched Sheet” button 522 to a non-selectable state. In this case, the “Envelope Flap” button 523 is the only sheet shape selection button selectable by the user. If “Set Sheet Size” is not “Envelope” (NO in step S43), the processing proceeds to step S45. In step S45, the control unit 300 sets the “Index Sheet” button 521 and the “Envelope Flap” button 523 to a non-selectable state. In this case, the “Pre-punched Sheet” button 522 is the only sheet shape selection button selectable by the user. Setting of a non-selectable button is performed based on a correspondence relationship stored in advance in the ROM 302 for each special shape (for example, the “Envelope Flap” button is hidden for the A4 size).

FIG. 12 illustrates an example of “Shape Selection Screen” according to the second embodiment, in which the “Index Sheet” button 521 and the “Pre-punched Sheet” button 522 are displayed in a non-selectable state. As illustrated in FIG. 12, when “Set Sheet Size” is “Envelope”, the “Index Sheet” button 521 and the “Pre-punched Sheet” button 522 are not necessary and thus displayed in a non-selectable state, and only the “Envelope Flap” button 523 is displayed as a button selectable by the user. The sheet shape selection buttons 521, 522, and 523 set to a non-selectable state are displayed in a dimmed manner so that the buttons cannot be pressed by the user. The sheet shape selection buttons 521, 522, and 523 set to a non-selectable state may not be displayed on “Shape Selection Screen”.

As described above, in the second embodiment, in a case where the automatic detection of the sheet characteristics by the medium sensor 280 is to be performed, “Shape Selection Screen” for prompting the user to input a special shape is displayed on the liquid crystal display 332, similar to the first embodiment. However, in the second embodiment, when “Shape Selection Screen” is displayed on the liquid crystal display 332, the control unit 300 prompts the user to input a special shape corresponding to “Set Sheet Size” from among a plurality of special shapes. Thus, on the “Shape Selection Screen”, the user is presented with a limited set of special shapes that can be input from among the plurality of special shapes. This prevents the user from mistakenly selecting a special shape not corresponding to “Set Sheet Size”, thereby improving user convenience.

### Third Embodiment

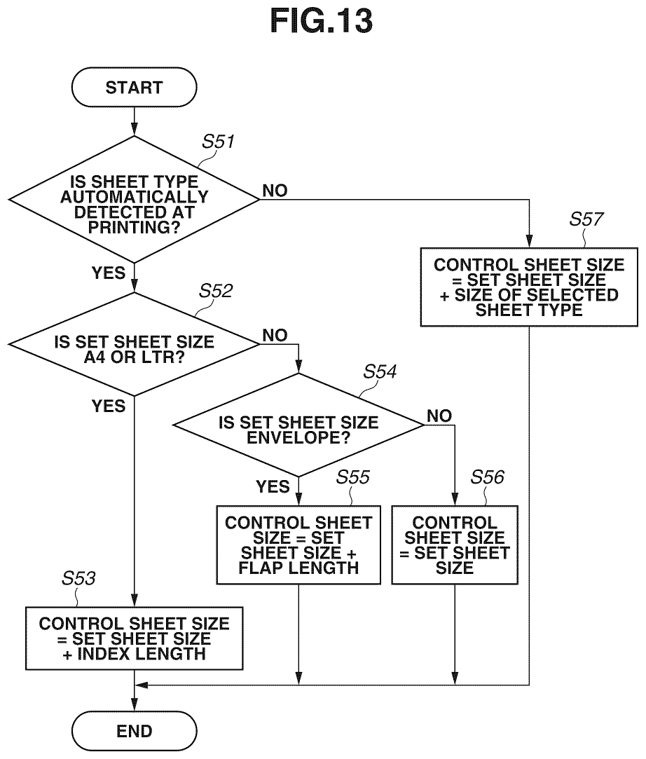

Next, a third embodiment will be described with reference to FIG. 13. In above-described first and the second embodiments, “Control Sheet Size” is set according to the special shape input by the user. In the third embodiment, “Control Sheet Size” for the sheet P having a special shape can be set without requiring the user to input the special shape. FIG. 13 illustrates “Control Sheet Size Setting Processing” according to the third embodiment. “Control Sheet Size Setting Processing” according to the third embodiment is performed during “Sheet Feed Processing” (step S12 in FIG. 8). In the third embodiment, “Set Sheet Size” is any one of predetermined sizes “A4”, “LTR”, or “Envelope” as in the second embodiment.

In step S51, the control unit 300 determines whether the “Automatically Detect at Printing” button 511 (see FIG. 7A) on the above-described “Setting Selection Screen” is pressed by the user, i.e., whether the automatic detection of the sheet characteristics by the medium sensor 280 is set to be performed. If the “Automatically Detect at Printing” button 511 is not pressed by the user, i.e., if the automatic detection of the sheet characteristics by the medium sensor 280 is not to be performed (NO in step S51), the processing proceeds to step S57. In step S57, the control unit 300 adds “Set Sheet Size” and the size of a sheet type selected from “Sheet Type Input Screen” (see FIG. 7C) by the user, and sets the resultant size to “Control Sheet Size”. For example, when “Envelope” is selected as the sheet type and “Set Sheet Size” is a Choukei No. 3 envelope (235 mm×120 mm), the control unit 300 sets “265 mm (235+30)” to “Control Sheet Size”.

If the “Automatically Detect at Printing” button 511 is pressed by the user, i.e., if the automatic detection of the sheet characteristics by the medium sensor 280 is to be performed (YES in step S51), the processing proceeds to step S52. In step S52, the control unit 300 determines whether “Set Sheet Size” is “A4” or “LTR”.

If “Set Sheet Size” is “A4” or “LTR” (YES in step S52), the processing proceeds to step S53. In step S53, the control unit 300 adds the sheet size of “A4” or “LTR” and “Index Length” stored in advance in the ROM 302 in association with “A4” or “LTR”, and sets the resultant size to “Control Sheet Size”. For example, when “Set Sheet Size” is “A4 Landscape”, the control unit 300 adds the index length “12.6 mm” corresponding to “A4 Landscape” to the length of the short side of the “A4 Landscape” whose sheet size is “210 mm×297 mm”, and sets the resultant size “222.6 mm” (210+12.6)” to “Control Sheet Size”.

If “Set Sheet Size” is neither “A4” nor “LTR” (NO in step S52), the processing proceeds to step S54. In step S54, the control unit 300 determines whether “Set Sheet Size” is “Envelope”.

If “Set Sheet Size” is “Envelope” (YES in step S54), the processing proceeds to step S55. In step S55, the control unit 300 adds the sheet size of “Envelope” and “Flap Length” stored in advance in the ROM 302 in association with “Envelope”, and sets the resultant size to “Control Sheet Size”. For example, when “Set Sheet Size” is “Choukei No. 3 Envelope”, the control unit 300 adds the flap length “30 mm” corresponding to “Choukei No. 3 Envelope” to the length of the long side of “Choukei No. 3 Envelope” whose sheet size is “235 mm×120 mm”, and sets the resultant size “265 mm” (235+30) to “Control Sheet Size”. If “Set Sheet Size” is not “Envelope” (NO in step S54), the processing proceeds to step S56. In step S56, the control unit 300 sets “Set Sheet Size” to “Control Sheet Size”.

As described above, in the present embodiment, in a case where the automatic detection of the sheet characteristics by the medium sensor 280 is to be performed, “Control Sheet Size” can be set for the sheet P having a special shape without displaying “Shape Selection Screen” (see FIG. 7B) on the liquid crystal display 332, i.e., without requiring the user to input the special shape. In the case where the automatic detection of the sheet characteristics by the medium sensor 280 is to be performed, the productivity may possibly decrease if the user is prompted to input a special shape according to “Shape Selection Screen”. In the case where the automatic detection of the sheet characteristics by the medium sensor 280 is to be performed, if “Control Sheet Size” is not set for the sheet P having a special shape, abnormalities such as a paper jam of the sheet P having a special shape in the conveyance path may occur. Thus, in a case where “Set Sheet Size” corresponds to a specific size (A4, LTR, or Envelope), the sheet P is regarded as having a special shape. In such a case, the control unit 300 adds a special shape size value such as an index value and a flap length corresponding to the specific size to “Set Sheet Size”, and sets a resultant size to “Control Sheet Size”. Accordingly, in the case where the automatic detection of the sheet characteristics by the medium sensor 280 is to be performed, the user is not required to input a special shape related to the specific size. This improves the user convenience and does not reduce the productivity of the image forming apparatus 1.

According to the present disclosure, it possible to improve the user convenience in using an image forming apparatus including a medium sensor.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-188096, filed Oct. 25, 2024, which is hereby incorporated by reference herein in its entirety.

What is claimed is:

1. An image forming apparatus that forms an image on a sheet, comprising:
a stacking unit on which sheets are stacked;
a conveyance unit configured to convey a sheet from the stacking unit;
a detection unit configured to detect characteristics of the sheet;
a display unit configured to display information; and
a control unit configured to control the display unit,
wherein, in a mode where the detection unit detects the characteristics of the sheet, the control unit controls the display unit to display a screen for inputting information about a sheet shape.

2. The image forming apparatus according to claim 1, wherein the information about the sheet shape includes at least information about an index sheet having an index portion, a pre-punched sheet having a hole formed therein, or an envelope having a flap in an open state.

3. The image forming apparatus according to claim 1, wherein, in a mode other than the mode where the detection unit detects the characteristics of the sheet, the control unit controls the display unit to display a screen for inputting information about a plurality of sheet types.

4. The image forming apparatus according to claim 1, further comprising an acquisition unit configured to acquire a size of the sheets stacked on the stacking unit,
wherein, in a case where the acquired size of the sheets is a predetermined size, the control unit displays, on the display unit, the information about sheet shapes predetermined for the predetermined size from information about a plurality of sheet shapes to be displayed on the screen in an un-selectable state.

5. The image forming apparatus according to claim 4,
wherein the stacking unit includes:
a first detection unit configured to detect whether a sheet is stacked;
a second detection unit configured to detect a length of the stacked sheets in a widthwise direction intersecting a conveyance direction; and
a third detection unit configured to detect whether a sheet is present based on the length of the stacked sheets in the conveyance direction, and
wherein the acquisition unit acquires the size of the sheets based on detection results of the first, second, and third detection units.

6. The image forming apparatus according to claim 1, further comprising an input unit configured accept input of information about the sheet shape from among a plurality of pieces of information about the sheet shape displayed on the display unit,
wherein, when an image forming job for forming an image on a sheet conveyed from the stacking unit is executed, the conveyance unit conveys the sheet from the stacking unit based on a conveyance interval between a preceding sheet and a subsequent sheet determined based on the information about the sheet shape.

7. The image forming apparatus according to claim 1, wherein the stacking unit is a manual feed tray.

8. The image forming apparatus according to claim 1, wherein the stacking unit is a sheet feed cassette.

9. A method for controlling an image forming apparatus that forms an image on a sheet and includes a stacking unit for stacking sheets and a conveyance unit that conveys sheets from the stacking unit, the method comprising:
detecting characteristics of the sheet;
displaying information; and
displaying, in a mode where the characteristics of the sheet are detected, a screen for inputting information about a sheet shape.

10. The method according to claim 9, wherein the information about the sheet shape includes at least information about an index sheet having an index portion, a pre-punched sheet having a hole formed therein, or an envelope having a flap in an open state.

11. The method according to claim 9, further comprising displaying, in a mode other than the mode where the characteristics of the sheet are detected, a screen for inputting information about a plurality of sheet types.

12. The method according to claim 9, further comprising acquiring a size of the sheets stacked on the stacking unit,
wherein, in a case where the acquired size of the sheets is a predetermined size, the information about sheet shapes predetermined for the predetermined size from information about a plurality of sheet shapes to be displayed on the screen is displayed in an un-selectable state.

13. The method according to claim 12, wherein acquiring the size of the sheets is based on detecting whether a sheet is stacked, detecting a length of the stacked sheets in a widthwise direction intersecting a conveyance direction, and detecting whether a sheet is present based on the length of the stacked sheets in the conveyance direction.

14. The method according to claim 9, further comprising accepting input of information about the sheet shape from among a plurality of pieces of information about the displayed sheet shape,
wherein, when an image forming job for forming an image on a sheet conveyed from the stacking unit is executed, the sheet is conveyed from the stacking unit based on a conveyance interval between a preceding sheet and a subsequent sheet determined based on the information about the sheet shape.
